(19) United States
(12) Patent Application Publication
(10) Pub. No.: US 2012/0298036 A1
(43) Pub. Date: Nov. 29, 2012

(54) LIQUID DROPLET DISCHARGING DEVICE

(75) Inventors: Masahiko OGAWA, Chino (JP); Tsuneo HANDA, Shimosuwa-machi (JP); Akihiko TSUNOYA, Suwa (JP)

(73) Assignee: SEIKO EPSON CORPORATION, Tokyo (JP)

(21) Appl. No.: 13/473,003

(22) Filed: May 16, 2012

(30) Foreign Application Priority Data
May 26, 2011 (JP) 2011-118116

(51) Int. Cl. B05B 1/00; B05B 15/00; B05B 12/00

(52) U.S. Cl. 118/712

(57) ABSTRACT

A liquid droplet discharging device includes a stage section, a discharge head, a moving section, a maintenance device and a testing device. The stage section is configured and arranged to retain a substrate. The discharge head has a nozzle for discharging a liquid droplet of a liquid onto the substrate. The moving section supports the discharge head to move integrally with the discharge head relative to the stage section. The maintenance device is configured and arranged to perform a predetermined maintenance process on the discharge head. The testing device is configured and arranged to test liquid droplet discharge characteristics of the nozzle. The maintenance device and the testing devices are disposed at opposite sides in a direction of relative movement of the moving section and the stage section, with the stage section being disposed therebetween.

### CROSS-REFERENCE TO RELATED APPLICATIONS

This application claims priority to Japanese Patent Application No. 2011-118116 filed on May 26, 2011. The entire disclosure of Japanese Patent Application No. 2011-118116 is hereby incorporated herein by reference.

### BACKGROUND

1. Technical Field

The present invention relates to a liquid droplet discharging device.

2. Related Art

Liquid droplet discharging devices that employ ultraviolet-curing inks cured by irradiation with ultraviolet to form images or patterns on recording media have attracted interest in recent years. Ultraviolet-curing inks have a characteristic that is desirable in a printing ink, namely, of being extremely slow to cure until irradiated with ultraviolet, but curing rapidly when irradiated with ultraviolet. Another advantage is that because there is no evaporation of solvent during curing, the environmental impact is low.

Furthermore, depending on the composition of the vehicle, ultraviolet-curing inks exhibit high adhesion to various types of recording media. Also, once cured, the inks are chemically stable and have outstanding characteristics such as high bonding, chemical resistance, weather resistance, wear resistance and the like, as well as ability to withstand outdoor environments. For this reason, images can be formed not only on recording media of thin sheet form such as paper, resin films, metal foil, and the like, but also on materials having surface contours that are somewhat three-dimensional, such as label surfaces of recording media, textile products, and the like. Techniques for printing attribute information, such as IC manufacturing number, manufacturer name, or the like, on a substrate by a liquid droplet discharge system using the aforedescribed ultraviolet-curing ink have been disclosed (for example, Japanese Laid-Open Patent Application Publication No. 2003-080687).

A liquid droplet discharging device of this kind may be furnished for example, with an testing device that employs an image-capturing device or the like to capture an image of an testing stage, after discharging liquid droplets onto the testing stage and subsequent curing thereof, in order to inspect in advance the conditions of ink discharge from the discharge head (for example, see Japanese Laid-Open Patent Application Publication No. 2006-142807 and Japanese Laid-Open Patent Application Publication No. 2003-341020).

### SUMMARY

However, the prior art discussed above has a number of problems, such as the following.

A liquid droplet discharging device is furnished with a maintenance device, such as a wiping mechanism, a nozzle suction mechanism, or the like, which is employed in cases of defective discharge of ink from the discharge head, in order to perform a cleaning operation and resolve the defective discharge. In the devices disclosed in Japanese Laid-Open Patent Application Publication No. 2006-142807 and Japanese Laid-Open Patent Application Publication No. 2003-341020, the discharge testing device is disposed in proximity to the maintenance device. Because of this, during discharge testing, the ultraviolet light irradiated for the purpose of curing the liquid droplets discharged onto the testing stage causes the ink remaining on the maintenance device to cure, which has the potential to cause difficulties.

This problem is not limited to cases in which ultraviolet-curing inks are employed, and there is a potential for similar difficulties to occur in cases in which thermal-curing inks are employed as well, if ink remaining on the maintenance device is caused to cure by heat employed for curing (drying) of the liquid droplets discharged onto the testing stage.

With the foregoing in view, it is an object of the present invention to provide a liquid droplet discharging device whereby discharge testing is executable with no adverse effects on maintenance devices.

According to the present invention, the following configuration is adopted in order to attain the aforedescribed object.

A liquid droplet discharging device according to one aspect of the present invention includes a stage section, a discharge head, a moving section, a maintenance device and a testing device. The stage section is configured and arranged to retain a substrate. The discharge head has a nozzle for discharging a liquid droplet of a liquid onto the substrate. The moving section supports the discharge head to move integrally with the discharge head relative to the stage section. The maintenance device is configured and arranged to perform a predetermined maintenance process on the discharge head. The testing device is configured and arranged to test liquid droplet discharge characteristics of the nozzle. The maintenance device and the testing devices are disposed at opposite sides in a direction of relative movement of the moving section and the stage section, with the stage section being disposed therebetween.

Consequently, with the liquid droplet discharging device according to the above described aspect of the present invention, even in cases in which ultraviolet light or other activation light, or heat, or some other form of energy is imparted in order to bring about curing of liquid droplets in the testing device, because the maintenance device is disposed to the opposite side of the stage section from the testing device, adverse effects such as curing of liquid remaining on the maintenance device by the imparted energy can be prevented.

In a preferred configuration of the aforedescribed liquid droplet discharging device, the testing device has a testing discharge section on which the liquid droplet is discharged from the nozzle, and an image capture section disposed in an area outside a movable range of the moving section, and configured and arranged to capture an image of the liquid droplet discharged on the testing discharge section, in an area outside the movable range of the moving section.

In the above described aspect of the present invention, in so doing, an image of liquid droplets discharged by the testing discharge section is captured in an area outside the movable range of the moving section, to test the liquid droplet discharge characteristics of the nozzles, and therefore there is no need to move the image capture section from the movable range of the moving section.

Consequently, according to the above described aspect of the present invention, it is possible to move the discharge head during testing of the nozzle discharge status, making it possible for testing of liquid droplet discharge characteristics to be performed in parallel with discharge of liquid droplets onto the substrate.

In a preferred configuration of the aforedescribed liquid droplet discharging device, the testing discharge section is configured and arranged to move between a position opposing the discharge head within the movable range of the moving section and a position opposing the image capture section in an area outside the movable range of the moving section with respect to the direction of the relative movement.

In the above described aspect of the present invention, in so doing, it is possible for liquid droplets for testing purposes to be discharged from the nozzles of the discharge head, at a position at which the testing discharge section opposes the discharge head; and for the testing discharge section to then move, making it possible for an image of liquid droplets at a position opposing the image capture section to be captured by the image capture device.

In a preferred configuration of the present invention, there is provided a controller configured to cause discharge of the liquid droplet from the nozzle to the testing discharge section to be executed each time the relative movement occurs.

In the above described aspect of the present invention, in so doing, it is possible to prevent discharge of liquid droplets onto the substrate from being performed in a state of defective discharge of liquid droplets from the nozzles, thereby wasting the substrate and the discharged ink.

In a preferred configuration of the liquid droplet discharging device, the discharge head is configured and arranged to discharge the liquid droplet of the liquid that is curable by activation light.

In the above described aspect of the present invention, in so doing, through activation light irradiation of liquid droplets discharged with high accuracy onto the substrate, a highly accurate liquid droplet discharging process can be executed rapidly, and with minimal environmental impact.

In a preferred configuration, the aforedescribed configuration is provided with irradiation sections disposed on both sides of the discharge head in the direction of the relative movement, and configured and arranged to irradiate the liquid droplet on the substrate with the activation light.

In the above described aspect of the present invention, in so doing, it is possible to bring about curing of the discharged liquid both at a first side and the other side in the direction of relative movement of the moving section, so that throughput can be improved. Moreover, in the above described aspect of the present invention, in a case in which liquid droplets have been discharged onto the testing discharge section at a first side in the direction of relative movement, it will be possible as well for activation light irradiation to be performed at the first side in question by the irradiation section positioned to the rear; and after the direction of relative movement has reversed, for activation light irradiation to be performed employing the irradiation section positioned to the front (the outside), whereby the movable range of the moving section can be smaller.

As used herein, the predetermined direction and the direction of relative movement are understood to encompass ranges of displacement caused by errors in manufacture or assembly.

### BRIEF DESCRIPTION OF THE DRAWINGS

Referring now to the attached drawings which form a part of this original disclosure:

FIG. 1 is a generic view showing a simplified configuration of a liquid droplet discharging device 1 according to an embodiment of the present invention;

FIG. 2 is a diagram showing arrangement of nozzles on a nozzle formation face of a liquid droplet discharge head;

FIG. 3 is a fragmentary sectional view showing the internal configuration of a liquid droplet discharge head;

FIG. 4 is a plan view showing principal components of the liquid droplet discharging device; and

FIGS. 5A to 5C are diagrams showing a procedure for carrying out a printing process.

### DETAILED DESCRIPTION OF EXEMPLARY EMBODIMENTS

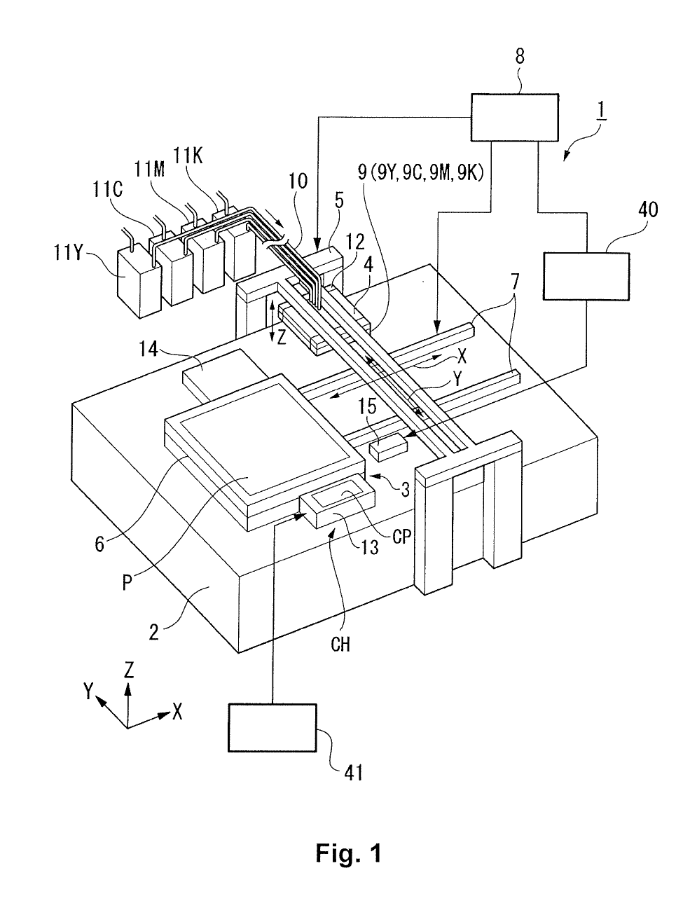

An embodiment of the liquid droplet discharging device of the present invention will be described with reference to FIGS. 1 to 5.

The following embodiment merely shows one aspect of the present invention, and should not be construed as limiting of the invention. Any number of modifications are possible within the scope of the technical idea of the present invention. In the following drawings, in order to aid in understanding of the configurations, the scale, number, etc., of structures in the drawings may differ from those of the actual structures.

For the purposes of the following description, the XYZ Cartesian coordinate system shown in FIG. 1 has been established, and the various components are described with reference to this XYZ Cartesian coordinate system. In the XYZ Cartesian coordinate system, the X axis and the Y axis are established in directions parallel to a stage (stage section) 6, and the Z axis is established in a direction orthogonal to the stage 6. In the XYZ Cartesian coordinate system of FIG. 1, in actual practice, the XY plane is established in a plane parallel to the horizontal plane, and the Z axis is established in a vertical upward direction. The direction of scanning movement of a liquid droplet discharge head (discharge head) 9 is designated as the Y direction (first direction), and the direction of movement of the stage 6 is designated as the X direction (second direction).

FIG. 1 is a generic view showing a simplified configuration of a liquid droplet discharging device 1 according to an embodiment of the present invention. The liquid droplet discharging device 1 is designed to discharge ink onto a recording medium P, for example, a plastic film or the like, and to irradiate the ink that has landed on the recording medium P with ultraviolet light to bring about curing, and print an image, various designs, or other such patterns on the recording medium P.

Ultraviolet-curing inks have a characteristic that is desirable in a printing ink, namely, of being extremely slow to cure until irradiated with ultraviolet, but curing rapidly when irradiated with ultraviolet. Another advantage is that because there is no evaporation of solvent during curing, the environmental impact is low.

Furthermore, depending on the composition of the vehicle, ultraviolet-curing inks exhibit high adhesion to various types of recording media. Also, once cured, the inks are chemically stable and have outstanding characteristics such as high bonding, chemical resistance, weather resistance, wear resistance and the like, as well as ability to withstand outdoor environments. For this reason, images can be formed not only on recording media of thin sheet form such as paper, resin films, metal foil, and the like, but also on materials having surface contours that are somewhat three-dimensional, such as label surfaces of recording media, textile products, and the like.

Herein, for convenience, when describing “ultraviolet-curing ink,” it is referred to simply as “ink.”

The liquid droplet discharging device 1 is equipped with a base 2 for placement of the recording medium (substrate) P is placed; a conveying device 3 for conveying the recording medium P on the base 2 in the X direction in FIG. 1; liquid droplet discharge heads 9 for discharging ink; a carriage (moving section) 4 provided with a plurality of the liquid droplet discharge heads 9; a feed device 5 for moving the carriage 4 in the Y direction (direction of relative movement); an ultraviolet irradiation section (irradiation section) 12; a testing stage (testing discharge section) 13 for placement of a testing medium CP; image capture means (image capture section) 15; a decision section 40; and a controller 8 for controlling the various constituent parts. The conveying device 3 and the feed device 5 constitute a moving device for producing relative movement of the recording medium P and the carriage 4 in the X direction and the Y direction, respectively.

The testing medium CP may be one comparable at least in the material of the surface thereof to the recording medium P, or one having substantially the same level of surface tension.

The aforedescribed testing stage 13, image capture means 15, and decision section 40 constitute the testing device CH according to the present invention.

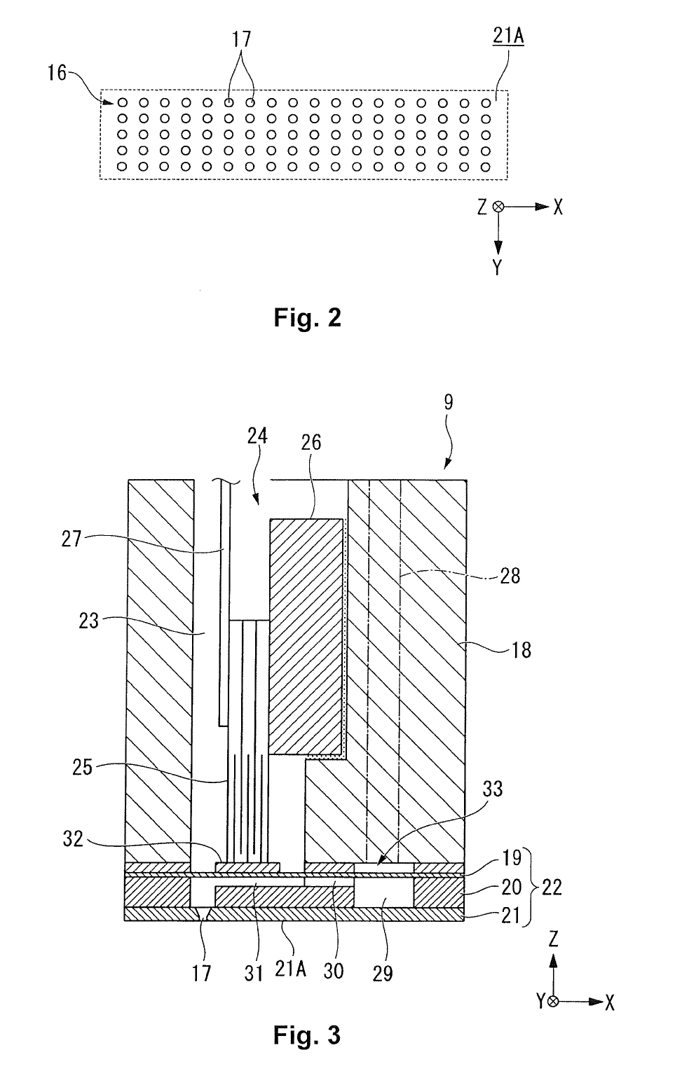

The liquid droplet discharge head 9 according to the present embodiment may be one that, under control by the controller 8, is able to discharge different amounts of ink through application of voltages of different waveforms corresponding to the nozzles 17 (see FIGS. 2 and 3). That is, the liquid droplet discharge head 9 may implement Multi Size Dot Technology (MSDT), which is a technique for printing out dots of mutually different sizes from nozzles.

The conveying device 3 is provided with a stage 6 and a stage moving device 7, which are furnished on the base 2. The stage 6 is furnished so as to be moveable in the X direction over the base 2 by the stage moving device 7, and as the recording medium P is conveyed from a conveying device (not shown) to the upstream side, retains the medium in the XY plane by a vacuum suction mechanism, for example.

The stage moving device 7 is provided with a ball and screw, linear guide, or other bearing mechanism; and is constituted so as to move the stage 6 in the X direction, based on a stage position control signal input from the controller 8, and showing X coordinates of the stage 6.

The carriage 4 is shaped like a rectangular plate moveably attached to the feed device 5, and is adapted to move in the Y direction while retaining a plurality of liquid droplet discharge heads 9 arrayed along the Y direction to the bottom face side thereof. The plurality of liquid droplet discharge heads 9 (9Y, 9C, 9M, 9K) are provided with a plurality of nozzles 17, to be discussed later, and are adapted to discharge liquid droplets of ink based on drawing data and a drive control signal input from the controller 8. The plurality of liquid droplet discharge heads 9 (9Y, 9C, 9M, 9K) respectively discharge inks corresponding to Y (yellow), C (cyan), M (magenta), and K (black). As shown in FIG. 1, tubes (conduits) 10 are linked to the respective liquid droplet discharge heads 9 via the carriage 4.

The liquid droplet discharge head 9Y corresponding to Y (yellow) is connected via a tube 10 to a first tank (ink storage chamber) 11Y filled with or holding Y (yellow) ink, whereby Y (yellow) ink may be supplied to the liquid droplet discharge head 9Y from this first tank 11Y. Similarly, the liquid droplet discharge head 9C corresponding to C (cyan) is connected to a second tank 11C filled with C (cyan) ink; the liquid droplet discharge head 9M corresponding to M (magenta) is connected to a third tank 11M filled with M (magenta) ink; and the liquid droplet discharge head 9K corresponding to K (black) is connected to a fourth tank 11K filled with K (black) ink. Through this configuration, the liquid droplet discharge head 9C is supplied with C (cyan) ink from the second tank 11C, the liquid droplet discharge head 9M is supplied with M (magenta) ink from the third tank 11M, and the liquid droplet discharge head 9K is supplied with K (black) ink from the fourth tank 11K.

Herein, the ink is of a type that cures when exposed to light of a predetermined wavelength, such as an ultraviolet curing ink, for example, and contains a monomer, a photopolymerization initiator, and a pigment corresponding to a color; optionally, various other additives such as surfactants, thermal radical polymerization inhibitors, and the like may be incorporated into the formulation as well. Because the wavelength band of the light (ultraviolet light) absorbed by such inks differ according to the components (formulation) thereof, the optimal value of the wavelength for curing, specifically, the optimal curing wavelength, will differ for each ink.

For example, the inks may be prepared by adding adjuvants such as antifoaming agents, polymerization inhibitors, or the like, to a mixture of a vehicle, a photopolymerization initiator, and a pigment. The vehicle is prepared from an oligomer, monomer, or the like having photopolymerization curing ability, and the viscosity is adjusted by a reactive diluent. Therefore, there is no solvent evaporation for the purpose of curing the ink.

Monofunctional or polyfunctional polymerizable compounds can be used as vehicles. In more specific terms, polyester acrylate, epoxy acrylate, urethane acrylate, and other oligomers (prepolymers) can be given as examples; these materials can also be employed as reactive diluents for adjusting ink viscosity.

Benzophenone-, benzoin-, acetophenone-, or thioxanthone-based photopolymerization initiators are widely employed. In more specific terms, a water-soluble organic compound of quaternary ammonium salt type, such as 4-benzoyl-N,N,N-trimethyl benzene methane ammonium chloride, 2-hydroxy 3-(4-benzoyl-phenoxy)-N,N,N-trimethyl 1-propane ammonium chloride, or 4-benzoyl-N,N-dimethyl N-[2-(1-oxo-2-propenyloxy)ethyl]benzene methammonium bromide, or the like can be employed. These types of photopolymerization initiators, depending on composition, will differ in their ultraviolet absorption characteristics, reaction initiation efficiency, yellowing, and so on, and are used selectively depending on ink color, etc.

As polymerization inhibitors, there can be used any compound that has radical scavenging ability and prevent radical polymerization. However, in consideration of suitability for discharge from the liquid droplet discharging device 1, at least one type of compound selected from hydroquinones, catechols, hindered amines, phenols, phenothiazines, and condensed-aromatic ring quinones is preferred.

Examples of hydroquinones include hydroquinone, hydroquinone monomethyl ether, 1-o-2,3,5-trimethylhydroquinone, 2-tert-butylhydroquinone, and the like. Examples of catechols include catechol, 4-methylcatechol, 4-tert-butylcatechol, and the like. Examples of hindered amines include compounds having a tetramethylpiperidinyl group, and the like.

Examples of phenols include phenol, butylhydroxytoluene, butylhydroxyanisole, pyrogallol, gallic acid, gallic acid alkyl esters, and the like. Examples of phenothiazines include phenothiazine and the like. Examples of condensed-aromatic ring quinones include naphthoquinone and the like.

Further, the polymerization inhibitor may be carbon black, or an inorganic or organic fine particulate having polymerization-inhibiting functional groups introduced on the surfaces. Examples of polymerization-inhibiting functional groups include, for example, the hydroxyphenyl group, the dihydroxyphenyl group, the tetramethylpiperidinyl group, condensed aromatic rings, and the like.

The description now turns to the configuration of the liquid droplet discharge heads 9, with reference to FIGS. 2 and 3. FIG. 2 is a diagram showing arrangement of the nozzles 17 on a nozzle formation face 21A of a liquid droplet discharge head 9. FIG. 3 is a fragmentary sectional view showing the internal configuration of a liquid droplet discharge head 9.

As shown in FIG. 2, on the nozzle formation face 21A, a plurality of the nozzles 17 are furnished along the conveying direction (X direction) of the recording medium P, forming nozzle rows 16. A total of five nozzle rows 16 are furnished along the scanning direction (Y direction) of the liquid droplet discharge head 9. The number of nozzles and the number of nozzle rows furnished to the liquid droplet discharge heads 9 may be freely modified. The liquid droplet discharge heads 9 are disposed with displacement in the lateral direction by the equivalent of one half of the pitch between the nozzles 17. In so doing, the resolution of printing of the recording medium P can be improved.

As shown in FIG. 3, the liquid droplet discharge head 9 is provided with a head body 18, and a flow passage-forming unit 22 connected to the head body 18. The flow passage-forming unit 22 is provided with an oscillator plate 19, a flow passage substrate 20, and a nozzle substrate 21; and forms a common ink chamber 29, and ink supply port 30, and a pressure chamber 31. The flow passage-forming unit 22 is further provided with an island section 32 that functions as a diaphragm section, and a compliance section 33 for absorbing pressure fluctuations inside the common ink chamber 29. A housing space 23 for housing a locking member 26 as well as a drive unit 24, and an internal flow passage 28 for guiding the ink to the flow passage-forming unit 22, are also formed in the head body 18.

According to the liquid droplet discharge head 9 having the aforedescribed configuration, when a drive signal is applied to the drive unit 24 via a cable 27, a piezoelectric element 25 expands and contracts. Because of this, the oscillator plate 19 deforms (moves) in a direction approaching the pressure chamber 31 (−Z direction) and a direction away from the pressure chamber 31 (+Z direction). Therefore, the capacity of the pressure chamber 31 changes, and the pressure in the pressure chamber 31 housing the ink fluctuates. Due to this fluctuation in pressure, ink is sprayed from the nozzle 17.

Returning to FIG. 1, the feed device 5 that moves the carriage 4 is one having, for example, a bridge structure spanning the base 2, and is provided with bearing mechanisms such as ball screws, linear guides, or the like, with respect to the Y direction and to the Z direction which is orthogonal to the XY plane. By virtue of this configuration, based on a carriage position control signal input from the controller 8 and showing Y coordinates and Z coordinates of the carriage 4, the feed device 5 moves the carriage 4 in the Y direction, as well as moving it in the Z direction.

On the carriage 4 shown in FIG. 1, for all of the liquid droplet discharge heads 9, ultraviolet irradiation sections 12 are respectively disposed in proximity to the liquid droplet discharge heads 9. In more specific terms, the ultraviolet irradiation sections 12 are furnished at both the front and back sides in the direction of movement of the carriage 4, and move in tandem with scanning movement of the liquid droplet discharge heads 9. The ultraviolet irradiation sections 12 are intended to bring about curing of ink discharged onto the recording medium P, and in the present embodiment are composed of a multitude of light-emitting diodes (LEDs). However, the present invention is not limited to LEDs, and the ultraviolet irradiation sections 12 may instead employ, for example, laser diodes (LDs), mercury lamps, metal halide lamps, xenon lamps, excimer lamps, and the like.

The light respectively irradiated by the LED ultraviolet irradiation sections 12 of the present embodiment has wavelengths corresponding to the optimal curing wavelengths of the inks ejected from the corresponding liquid droplet discharge heads 9Y, 9C, 9M, 9K. That is, as noted previously, the optimal curing wavelengths of the inks differ depending on the components (formulation) thereof, and the ultraviolet irradiation sections 12 for these are designed to irradiate the corresponding inks with light having their optimal curing wavelength.

The image capture means 15 (herein a single unit is disposed) is disposed to the −Y side of the stage 6 in the same manner as the testing stage 13, and to the −X side which is an area outside the range of possible movement of the carriage 4. The image capture means 15 is one adapted to capture an image of a dot pattern formed on the test medium CP, in order to test the ink discharge characteristics of the nozzles 17. As the image capture means 15 there may be employed, for example, a CCD camera, scanner unit, or the like. Various types of data captured by the image capture means 15 is input to the decision section 40.

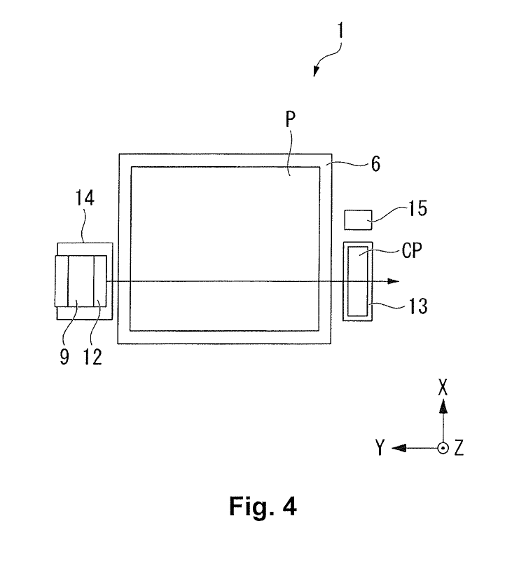

The testing stage 13 is disposed to the −Y side of the stage 6, and is furnished so as to be moveable in the X direction over the base 2 by a drive device 41. That is, the testing stage 13 is designed to move in the X direction independently of the stage 6 discussed previously. In more specific terms, as shown in FIG. 4, through driving by the drive device 41, the testing stage 13 is moveable between a position opposing (the range of possible movement of) the liquid droplet discharge heads 9 to the −Z side of the carriage 4 (liquid droplet discharge heads 9), and a position opposing the image capture means 15 in the area outside the range of possible movement of the liquid droplet discharge heads 9. This testing stage 13 retains the testing medium CP, for example, a plastic film or the like, in the XY plane by a vacuum suction mechanism, for example.

The controller 8 outputs a stage position control signal to the stage moving device 7, outputs a carriage position control signal to the feed device 5, and further outputs print data and a drive control signal to a drive circuit board (not shown) of the liquid droplet discharge heads 9. In so doing, the controller 8 performs synchronous control of a recording medium P positioning operation through movement of the stage 6 and a liquid droplet discharge head 9 positioning operation through movement of the carriage 4, to bring about relative movement of the recording medium P and the carriage 4; and additionally prompts the liquid droplet discharge heads 9 to perform liquid droplet discharging operations, thereby placing liquid droplets of ink at predetermined positions on the recording medium P or the testing medium CP. Apart from prompting the liquid droplet discharge heads 9 to perform liquid droplet discharging operations, the controller 8 prompts the ultraviolet irradiation sections 12 to perform an irradiation operation.

In a liquid droplet non-discharge area positioned to the +Y side on the opposite side of the stage 6 from the testing stage 13 and the image capture means 15 in the Y direction in the base 2, there is furnished a maintenance device 14 for performing maintenance (for example, a discharge recovery operation, cleaning, flushing, or the like) of the liquid droplet discharge heads 9 at times of non-printing. The maintenance device 14 is provided with a wiping mechanism, a nozzle suction mechanism capable of sealing the nozzle formation faces 21A of the liquid droplet discharge heads 9 (neither is illustrated), or the like. At least one mechanism from among a nozzle suction mechanism, a wiping mechanism, and the like may be provided by way of the maintenance device 14.

The description continues on to the procedure for discharging ink onto the recording medium P to carry out the printing process by the liquid droplet discharging device 1 having the aforedescribed configuration.

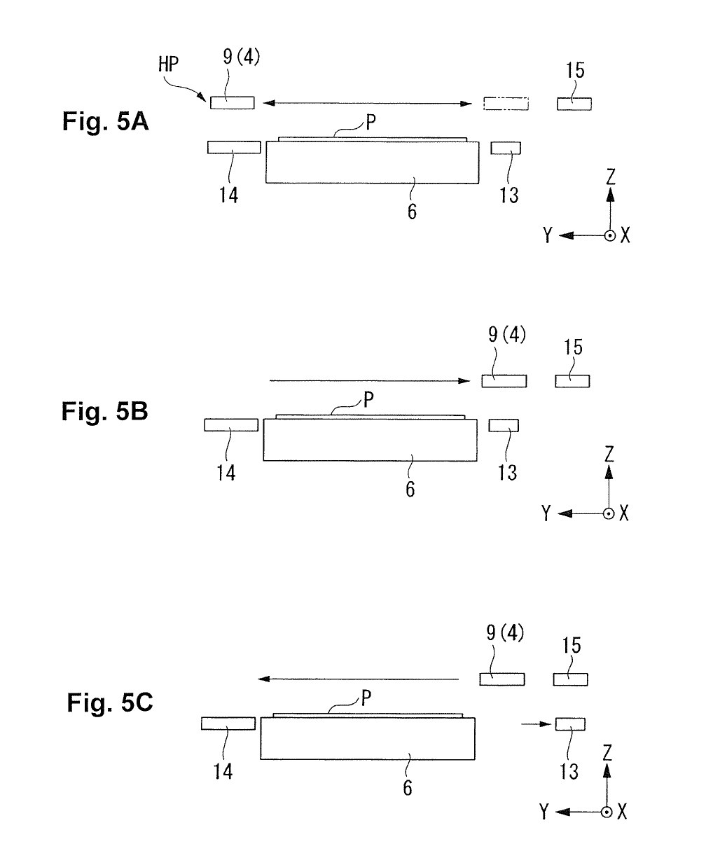

Prior to the process of discharging ink onto the recording medium P, the controller 8 (see FIG. 1) places the carriage 4 (liquid droplet discharge heads 9) in standby at a home position HP in opposition to the maintenance device 14 as shown in FIGS. 4 and 5A.

As shown in FIG. 1, the carriage 4 moves in the Y direction, whereas the testing stage 13 moves in the X direction; however, in FIGS. 5A to 5C, the illustration makes it appear to move in the Y direction, in order to aid understanding.

Depending on their service history, an appropriate maintenance process is performed on the liquid droplet discharge heads 9 standing by at the home position HP. Upon initiation of the ink discharge process, for example, air bubbles inside the liquid droplet discharge heads 9 may be expelled by the nozzle suction mechanism, followed by wiping of the nozzle formation faces 21A by the wiping mechanism.

In cases in which no maintenance process is performed, or after a maintenance process has completed, the controller 8 controls the drive device 41 to position the testing stage 13 below the path of movement of the carriage 4 as shown in FIG. 5B. The controller 8 then controls the feed device 5 to bring about scanning movement (relative movement) of the liquid droplet discharge heads 9 in the −Y direction to a position opposing the testing medium CP on the testing stage 13.

At this time, the controller 8 performs control to move the liquid droplet discharge heads 9 at a steady scanning speed (relative movement speed), while discharging ink towards the testing medium CP on the testing stage 13 from the nozzles 17 of the liquid droplet discharge heads 9. Additionally, the ultraviolet irradiation section 12 that is positioned to the back in the scanning direction is prompted to irradiate with ultraviolet light the ink which has been discharged onto the testing medium CP, to bring about curing thereof. The ultraviolet light for irradiation of the testing ink irradiated at comparable intensity and by a comparable method to the ultraviolet light for irradiation of ink discharged onto the recording medium P retained on the stage 6.

In so doing, a dot pattern is formed by the ink that has landed on the testing medium CP. Once ink has been discharged onto the testing medium CP, the controller 8 controls the drive device 41 to position the testing stage 13 below the image capture means 15 as shown in FIG. 5C. Once the testing stage 13 moves to a position in opposition to the image capture means 15, an image of the aforedescribed dot pattern is captured by the image capture means 15, and the captured data is input to the decision section 40 (see FIG. 1).

Based on the dot pattern captured by the image capture means 15, the decision section 40 decides whether defective discharge (ink discharge characteristics), such as dot dropout, landing position displacement due to deflected flight, abnormal values for dot diameter, or the like, has occurred in the nozzles 17. Therefore, the existence of defective discharge can be determined for each of the nozzles 17.

The controller 8 also controls the discharge operations of the liquid droplet discharge heads 9 in such a way that ink is not discharged from nozzles that have been decided to be experiencing defective discharge such as dot dropout, in the decision result of the decision section 40. That is, the controller 8 creates print data in such a way that nozzles experiencing defective discharge are not used. In so doing, even in cases of defective discharge, because the printing pattern is changed, delays in discharge operations by the liquid droplet discharge heads 9 can be minimized.

A discharge recovery process may be performed on the liquid droplet discharge heads 9 by the maintenance device 14 discussed previously (see FIG. 1), in order that nozzles that have been decided to be experiencing defective discharge in the decision result of the decision section 40 can recover their ink discharge functionality. That is, the maintenance device 14 performs a discharge recovery process on nozzles that have been decided to be experiencing defective discharge. In so doing, even in cases of defective discharge, the defective discharge can be resolved.

The processes that take place in cases of defective discharge are now described in detail.

(1) In a case in which dot dropout has occurred, the most reliable countermeasure is to execute a cleaning process; however, doing so adversely affects throughput; temporarily halts printing, whereby discontinuities in image quality are prone to occur; and renders defective the recording medium P being printed, thereby creating a problem of increased cost in association with defects. Because of this, it is preferable to continue printing while substituting good nozzles for defective nozzles, rather than suspending printing. In a normal printing process, once a single scanning movement is finished, the next main scan of printing continues after moving in the sub-scanning direction (X direction) by the equivalent of N nozzles; however, a flawed printing pattern can be repaired by moving in the sub-scanning direction by a distance equivalent to M/N nozzles (where N and M are positive integers such that M<N), and using good nozzles to reprint the flawed printed portions associated with the defective nozzles. In this case, the number of main scans is at most doubled, and the time to form a single image is prolonged. However, this approach is effective in preventing increased cost in association with defects.

(2) In a case in which landing position displacement has occurred, increased cost in association with defects may be prevented by a process comparable to that for dot dropout. However, because this is not a perfect countermeasure for landing position defects, defects may be prevented from becoming noticeable, in the following manner. Firstly, because position displacement is not noticeable in areas of high brightness (for example, areas of predominantly yellow, or areas of low ink density (light tone representation)), no supplemental process is performed, whereas in areas of dense color, because white banding associated with position displacement is noticeable, the white banding is eliminated by being printed over by nozzles having negligible position displacement. Printing of the portions in question is performed by moving by the equivalent of M/N nozzles in the sub-scanning direction, as in (1).

(3) In a case in which dot diameter defects have occurred, because variations in the characteristics of the liquid droplet discharge heads 9 per se do not readily arise apart from instances of damage or reaching the end of the lifespan, defects may be attributed to variations in surface tension or viscosity of the inks; however, at the same time, the compositions of the inks vary as well, and it is conceivable that the aforedescribed printing characteristics could be affected. Accordingly, the countermeasure will depend on the condition of occurrence of the defects.

In specific terms, in a case in which a plurality of nozzles 17 are experiencing defects overall irrespective of the type of ink, possible countermeasures include adjusting the ink discharge voltage, the head temperature, the platen temperature, or the like. In this case, it is preferable to create in advance a table of combinations of parameters, for each amount of variation of dot diameter. In a case of variation of dot diameter of ink of a specific color only, if the extent of variation is small, countermeasures include adjusting the ink discharge voltage of the head in question, or adjusting the ink temperature of head. Alternatively, in the case of Multi Size Dot print control and control to print out ink dots of several sizes, a possible countermeasure would be to manipulate the dot size data for defective nozzles or defective inks, in such a way that that data is shifted in several stages corresponding to the fluctuating amount of discharged ink. In this case, degradation in image quality can be kept to a minimum through fine adjustments to each of the nozzles 17. On the other hand, in the case that defects occur with ink of a specific color only, and the extent of variation of the ink is considerable, for example, in excess of 50%, a possible countermeasure would be to discharge each single dot twice. In so doing, image quality defects can be improved, and increased cost in association with defects can be minimized.

Meanwhile, the liquid droplet discharge heads 9 that discharged ink onto the testing medium CP, having passed over the testing stage 13, now undergo scanning movement in the +Y direction by decelerating and reversing the scanning direction of the carriage 4. At this time, in a case in which defective discharge was detected during the aforedescribed testing, and a maintenance process is to be performed, the liquid droplet discharge heads 9 are moved to a position opposing the maintenance device 14 without discharging ink onto the recording medium P, and thereafter the maintenance process is executed.

In a case in which no defective discharge in detected from the aforedescribed test results, a defective discharge was eliminated through a maintenance process, or nozzles 17 not experiencing defective discharge are used, during scanning movement of the liquid droplet discharge heads 9, ink is discharged from the liquid droplet discharge heads 9 onto the recording medium P on the stage 6. Then, discharge of ink onto the recording medium P through scanning movement in the Y direction, and relative movement in the X direction (sub-scanning direction) with respect to the stage 6, are repeated in order to print a predetermined pattern on the recording medium P.

Here, in preferred practice, testing of ink discharge characteristics as discussed above is carried out, for example, each time there is relative movement, in order to avoid situations in which, due to defective discharge arising after testing, when ink is subsequently discharged onto the recording medium P the ink discharge process takes place in a state of a defective discharge having arisen, thus wasting the recording medium P and the ink. However, in a case in which testing is performed for each single scanning movement, it will be necessary, for example, for the carriage 4 and the liquid droplet discharge heads 9, after having been scanned to the +Y side, to then move to the −Y side without discharging ink onto the recording medium P, to thereby be positioned above the testing stage 13, resulting in the possibility of reduced throughput. For this reason, from the standpoint of throughput, it is preferable for testing of ink discharge characteristics to be performed after each two scanning movements (each single reciprocation), with the carriage 4 and the liquid droplet discharge heads 9 positioned at the testing stage 13 side subsequent to scanning movement thereof.

In the above manner, according to the present embodiment, the maintenance device 14 and the testing stage 13 are disposed on opposite sides of the stage 6, and therefore even though the ink discharged onto the testing medium CP is cured by irradiation with ultraviolet light during testing of ink discharge characteristics, ink remaining on the maintenance device 14 is not cured by the ultraviolet light, and associated difficulties can be prevented.

Additionally, according to the present embodiment, the image capture means 15 is disposed in an area outside the range of possible movement of the liquid droplet discharge heads 9, and because the testing stage 13 moves between a position in opposition to the liquid droplet discharge heads 9 and a position in opposition to the image capture means 15, there is no need for the image capture means 15 to be moved within the range of possible movement of the liquid droplet discharge heads 9. Therefore, according to the present embodiment, it is possible for the liquid droplet discharge heads 9 to be moved during testing of ink discharge characteristics, making it possible for ink discharge onto the recording medium P and testing of ink discharge characteristics to be performed in parallel. Therefore, according to the present embodiment, it is possible to improve print quality while minimizing the reduction in printing speed.

Moreover, according to the present embodiment, because of a configuration whereby the testing stage 13 undergoes reciprocating movement in only a single direction, the structure is simple, accuracy of positioning is high, and moving time is short. Also, by virtue of this configuration, the inkjet head carriage has to move only a short distance in the main scanning direction, even where a scanner unit is furnished.

Additionally, according to the present embodiment, testing of ink discharge characteristics is performed every time there is a single scanning movement, and therefore it is possible to avoid situations in which, due the ink discharge process being performed in a state of a defective discharge having arisen, the recording medium P and the ink are wasted.

While the preferred embodiment of the present invention has been described above with reference to the accompanying drawings, the present invention is in no way limited to the example in question. The shapes, combinations, etc., of constituent members shown in the example discussed above are merely examples, and various modifications based on design requirements are possible without diverging from the spirit of the present invention.

For example, in the preceding embodiment, the image capture means 15 is disposed at the −X side, which is an area outside the range of possible movement of the carriage 4, and the testing stage 13 is moved in the X direction. However, there is no limitation thereto; e.g., the image capture means 15 could instead disposed at the −Y side, which is an area outside the range of possible movement of the carriage 4, and the testing stage 13 moved in the Y direction.

In the case of a configuration in which the testing stage 13 is moved in the X direction as discussed previously, the size of the liquid droplet discharging device 1 can be smaller in relation to the Y direction, which is the direction of movement of the carriage 4; whereas in the case of a configuration in which the testing stage 13 is moved in the Y direction, for example, the feed device 5 that moves the carriage 4 in the Y direction may be employed as the drive device for moving the testing stage 13 in the Y direction, thereby reducing the number of parts of the device, and contributing to lower cost.

Additionally, in the case of a configuration in which the testing stage 13 is moved in the Y direction, it is preferable for the length of the image capture means 15 to be greater than the length of the nozzle rows 16 of the liquid droplet discharge heads 9 (for the image capture range of the image capture means 15 to be larger than the ink discharge range of nozzle row 16). By adopting this configuration, the ink discharged from the nozzle rows 16 can be image-captured all at once, shortening the time needed for testing of ink discharge characteristics.

Whereas the preceding embodiment showed an example of a configuration in which the maintenance device 14 is disposed to the +Y side of the stage 6, while the testing stage 13 and the image capture means 15 are disposed to the −Y side of the stage 6, a configuration in which the maintenance device 14 is disposed to the −Y side of the stage 6, while the testing stage 13 and the image capture means 15 are disposed to the +Y side of the stage 6, is also acceptable. However in a case in which the testing stage 13 and the image capture means 15 are disposed at the same side as the tanks 11Y, 11C, 11M, and 11K, it is possible that stray light from the ultraviolet light from the ultraviolet irradiation sections 12 irradiating the ink discharged onto the testing medium CP will have an adverse effect on the inks of several colors stored in the tanks 11Y, 11C, 11M, and 11K. It is therefore preferable, as shown in the preceding embodiment, for the testing stage 13 and the image capture means 15 to be disposed on the opposite side of the stage 6 from the tanks 11Y, 11C, 11M, and 11K.

Additionally, whereas in the preceding embodiment, ultraviolet-curing ink was employed as the liquid for curing by activation light, the present invention is not limited thereto, and various other activation light-curing inks for which visible light or infrared light can be used as the curing light are also acceptable.

Likewise, as the light source, various activation light sources that emit activation light such as visible light may be employed, that is, employed as the activation light irradiation section.

In the present invention, the “activation light” is not particularly limited provided that irradiation thereof can impart energy to generate an initiating species in the ink, and is defined broadly to include α rays, γ rays, X-rays, ultraviolet light, visible light, electron beams, and the like. From the standpoint of curing sensitivity and ease of procuring equipment, ultraviolet light and electron beams are preferred, with ultraviolet light being especially preferred. Consequently, as the activation light-curing inks, it is preferable to employ ultraviolet-curing inks curable through irradiation with ultraviolet light, as taught in the present embodiment.

Additionally, whereas the preceding embodiment showed a configuration employing ultraviolet-curing inks, there is no limitation thereto, and it is possible for the present invention to be implemented in cases in which thermal curing inks are employed.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A liquid droplet discharging device comprising:
a stage section configured and arranged to retain a substrate;
a discharge head having a nozzle for discharging a liquid droplet of a liquid onto the substrate;
a moving section supporting the discharge head to move integrally with the discharge head relative to the stage section;
a maintenance device configured and arranged to perform a predetermined maintenance process on the discharge head; and
a testing device configured and arranged to test liquid droplet discharge characteristics of the nozzle,
the maintenance device and the testing devices being disposed at opposite sides in a direction of relative movement of the moving section and the stage section, with the stage section being disposed therebetween.

2. The liquid droplet discharging device of claim 1, wherein
the testing device has
a testing discharge section on which the liquid droplet is discharged from the nozzle, and
an image capture section disposed in an area outside a movable range of the moving section, and configured and arranged to capture an image of the liquid droplet discharged on the testing discharge section, in an area outside the movable range of the moving section.

3. The liquid droplet discharging device of claim 2, wherein
the testing discharge section is configured and arranged to move between a position opposing the discharge head within the movable range of the moving section and a position opposing the image capture section in an area outside the movable range of the moving section with respect to the direction of the relative movement.

4. A liquid droplet discharging device comprising:
a stage section configured and arranged to retain a substrate;
a discharge head having a nozzle for discharging a liquid droplet of a liquid onto the substrate;
a moving section supporting the discharge head to move integrally with the discharge head relative to the stage section;
a maintenance device configured and arranged to perform a predetermined maintenance process on the discharge head;
a testing discharge section on which the liquid droplet is discharged from the nozzle; and
an image capture section configured and arranged to capture an image of the liquid droplet discharged on the testing discharge section,
the maintenance device and the testing discharge section being disposed at opposite sides in a direction of relative movement of the moving section and the stage section, with the stage section being disposed therebetween.

5. The liquid droplet discharging device of claim 1, further comprising
a controller configured to cause discharge of the liquid droplet from the nozzle to the testing discharge section to be executed each time the relative movement occurs.

6. The liquid droplet discharging device of claim 1, wherein
the discharge head is configured and arranged to discharge the liquid droplet of the liquid that is curable by activation light.

7. The liquid droplet discharging device of claim 6, further comprising
irradiation sections disposed on both sides of the discharge head in the direction of the relative movement, and configured and arranged to irradiate the liquid droplet on the substrate with the activation light.
